(19) United States
(12) Patent Application Publication
(10) Pub. No.: US 2017/0228700 A1
(43) Pub. Date: Aug. 10, 2017

(54) INFORMATION PROVIDING SYSTEM AND METHOD

(71) Applicant: NAVER Corporation, Seongnam-si, Gyeonggi-do (KR)

(72) Inventors: Hyun Soo KIM, Seongnam-si (KR); Kyung Hwa CHUNG, Seongnami-si (KR); Shin Hye LEE, Seongnami-si (KR); Hyo Jung KIM, Seongnami-si (KR)

(73) Assignee: NAVER Corporation, Seongnam-si, Gyeonggi-do (KR)

(21) Appl. No.: 15/501,355

(22) PCT Filed: Jul. 30, 2015
(86) PCT No.: PCT/KR2015/008016

§ 371 Date: Feb. 2, 2017

(30) Foreign Application Priority Data
Aug. 6, 2014 (KR) 10-2014-0101095

(51) Int. Cl. G06Q 10/10; G06N 5/04

(52) U.S. Cl. CPC G06Q 10/1095; G06N 5/04; H04L 67/22

(57) ABSTRACT

An information providing system is provided. The information providing system includes a collector that collects user related information, a generator that generates predicted user interest information based on the user related information collected by the collector, a searcher that searches for an event corresponding to the predicted user interest information and including certain time information, and a controller that outputs, on a timeline dividing time, event contents including the time information corresponding to the time of the timeline.

### CROSS-REFERENCE TO RELATED APPLICATIONS

This application is a national phase application under 35 U.S.C. §371 of PCT International Application No. PCT/KR2015/008016 which has an International filing date of Jul. 30, 2015, which claims priority to Korean Patent Application No. 10-2014-0101095 filed on Aug. 6, 2014, the entire contents of each of which are hereby incorporated by reference.

### TECHNICAL FIELD

The present invention relates to information providing systems and methods.

### BACKGROUND ART

Recently, there has been a need for a context awareness based mobile service and various technologies for responding to such a need are rapidly developing. A context awareness based service estimates a location of a user, physical, social, psychological environment factors at the position of the user, and an individual preference of the user, based on analysis of sensor information and individual information presented by the user himself or herself, and automatically selects and provides a service corresponding with a user environment based on the estimation.

To this end, mobile terminals, such as smartphones, tablet personal computers (PCs), or notebook computers, perform context awareness including location awareness through sensors and extract necessary context information through a context awareness engine provided in the mobile terminal or a remote server and configured to manage actual context awareness. A service selected based on such extracted context information is provided to an actual user through an individualization or adaptation process.

### DETAILED DESCRIPTION OF THE INVENTION

### Technical Problem

The present invention has been made in an effort to solve the above-described problems and/or limitations and an object of the present invention is to predict user interest information based on user related information and provide event contents including time information corresponding to predicted interest information according to time on a timeline, so that a user need not unnecessarily spend a search time in confirming event contents of interest.

Also, an object of the present invention is to predict user interest information based on user related information and provide event contents including time information corresponding to predicted interest information according to time on a timeline, so that users can quickly and easily confirm different event contents.

Also, an object of the present invention is to allow a user to quickly and easily confirm event contents corresponding to a past time and/or a future time according to time selection from a timeline.

### Technical Solution

An information providing system according to an embodiment of the present invention includes: a collector that collects user related information; a generator that generates predicted user interest information based on the user related information collected by the collector; a searcher that searches for an event including certain time information corresponding to the predicted user interest information; and a controller that outputs, on a timeline dividing time, event contents including the time information corresponding to the time of the timeline.

The collector may collect the user related information including a text input by the user, and the generator may generate the predicted user interest information including the text.

The collector may collect the user related information including a browsing history of the user, and the generator may generate the predicted user interest information including text information included in the browsing history.

The collector may collect the user related information including schedule information of the user, and the generator may generate the predicted user interest information corresponding to the schedule information.

The collector may collect the user related information including information set by the user, and the generator may generate the predicted user interest information corresponding to the information set by the user.

The collector may collect the user related information including context information of the user, and the generator may generate the predicted user interest information corresponding to the context information.

The searcher may search for a public interest event corresponding to public interest information except for the predicted user interest information, and the controller may control outputting of contents of the public interest event.

The controller may control outputting of main event contents as an event corresponding to a first ranking among the events, whose ranking is set, by reception of gestures of a first direction and a second direction from event contents including the timeline, and control outputting of detailed event contents related to the main event contents by reception of a gesture of a third direction.

The controller may control outputting of event contents including time information corresponding to a gesture of a first direction by reception of the gesture of the first direction from event contents including the timeline, and control outputting of event contents including time information corresponding to a gesture of a second direction by reception of the gesture of the second direction from event contents including the timeline.

The controller may control outputting of event contents including time information corresponding to a gesture of a first direction by reception of the gesture of the first direction on the timeline, and control outputting of event contents including time information corresponding to a gesture of a second direction by reception of the gesture of the second direction on the timeline.

The controller may control outputting of event contents including the time information matching a selected certain time in response to reception of a gesture of selecting the certain time on the timeline.

An information providing method according to an embodiment of the present invention includes: collecting, by an information providing system, user related information; generating, by the information providing system, predicted user interest information based on the collected user related information; searching for, by the information providing system, an event including certain time information corresponding to the predicted user interest information; and outputting, by the information providing system, on a timeline dividing time, event contents including the time information corresponding to the time of the timeline.

The collecting may include collecting the user related information including a text input by the user, and the generating may include generating the predicted user interest information including the text.

The collecting may include collecting the user related information including a browsing history of the user, and the generating may include generating the predicted user interest information including text information included in the browsing history.

The collecting may include collecting the user related information including schedule information of the user, and the generating may include generating the predicted user interest information corresponding to the schedule information.

The collecting may include collecting the user related information including information set by the user, and the generating may include generating the predicted user interest information corresponding to the information set by the user.

The collecting may include collecting the user related information including context information of the user, and the generating may include generating the predicted user interest information corresponding to the context information.

The searching may include searching for a public interest event corresponding to public interest information except for the predicted user interest information, and the outputting may include outputting contents of the public interest event.

The outputting may include: outputting main event contents as an event corresponding to a first ranking among the events, whose ranking is set, by reception of gestures of a first direction and a second direction from event contents including the timeline; and outputting detailed event contents related to the main event contents by reception of a gesture of a third direction.

The outputting may include: outputting event contents including time information corresponding to a gesture of a first direction by reception of the gesture of the first direction from event contents including the timeline; and outputting event contents including time information corresponding to a gesture of a second direction by reception of the gesture of the second direction from event contents including the timeline.

The outputting may include: outputting event contents including time information corresponding to a gesture of a first direction by reception of the gesture of the first direction on the timeline; and outputting event contents including time information corresponding to a gesture of a second direction by reception of the gesture of the second direction on the timeline.

The outputting may include outputting event contents including the time information matching a selected certain time in response to reception of a gesture of selecting the certain time on the timeline.

Furthermore, other methods and systems for implementing the present invention and non-transitory computer-readable recording media having recorded thereon a computer program for performing the methods may be further provided.

Other aspects, features, and advantages will be apparent from the following detailed description and claims, taken in conduction with the accompanying drawings.

### Advantageous Effects of the Invention

According to embodiments, user interest information is predicted based on user related information and event contents including time information corresponding to predicted interest information are provided according to time on a timeline. Thus, it is convenient for a user because the user need not unnecessarily spend a search time in confirming event contents of interest

Also, user interest information is predicted based on user related information and event contents including time information corresponding to predicted interest information are provided according to time on a timeline, so that users can quickly and easily confirm different event contents.

Also, the user can quickly and easily confirm event contents corresponding to a past time and/or a future time according to time selection from a timeline.

### DESCRIPTION OF THE DRAWINGS

FIG. 1 is a diagram generally describing an information providing system according to an embodiment of the present invention.

FIG. 2 is a diagram for describing a relationship between user terminals and the information providing system of FIG. 1, according to an embodiment of the present invention.

FIG. 3 is a diagram for describing a relationship between a user terminal and the information providing system of FIG. 1, according to another embodiment of the present invention.

FIG. 4 is a diagram for describing a relationship between a user terminal and the information providing system of FIG. 1, according to another embodiment of the present invention.

FIG. 5 is a diagram generally describing an information providing system according to another embodiment of the present invention.

FIG. 6 is a diagram illustrating an example of an information providing screen according to an embodiment of the present invention.

FIG. 7 is a diagram illustrating an example of an information providing screen according to another embodiment of the present invention.

FIG. 8 is a diagram illustrating an example of an information providing screen according to another embodiment of the present invention.

FIG. 9 is a diagram illustrating an example of an information providing screen according to another embodiment of the present invention.

FIG. 10 is a diagram illustrating an example of an information providing screen according to another embodiment of the present invention.

FIG. 11 is an operation flowchart of an information providing method according to an embodiment of the present invention.

### BEST MODE

Advantages, features, and how to achieve them of the present invention will become apparent by reference to the embodiment that will be described later in detail, together with the accompanying drawings. The present invention may be embodied in many different forms and should not be construed as being limited to the embodiments set forth herein; rather, these embodiments of the present invention are provided so that this disclosure will be thorough and complete, and will fully convey the concept of the present invention to those skilled in the art. In the following description, detailed descriptions of well-known functions or configurations will be omitted since they would unnecessarily obscure the subject matters of the present invention.

The terms used in the present specification are merely used to describe particular embodiments, and are not intended to limit the present invention. As used herein, the singular forms “a”, “an”, and “the” are intended to include the plural forms as well, unless the context clearly indicates otherwise. It will be understood that the terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof. It will be understood that although the terms “first”, “second”, etc. may be used herein to describe various components, these components should not be limited by these terms. These components are only used to distinguish one component from another.

Hereinafter, embodiments of the present invention will be described with reference to the accompanying drawings. Like reference numerals denote like elements throughout the specification and drawings, and redundant descriptions thereof will be omitted.

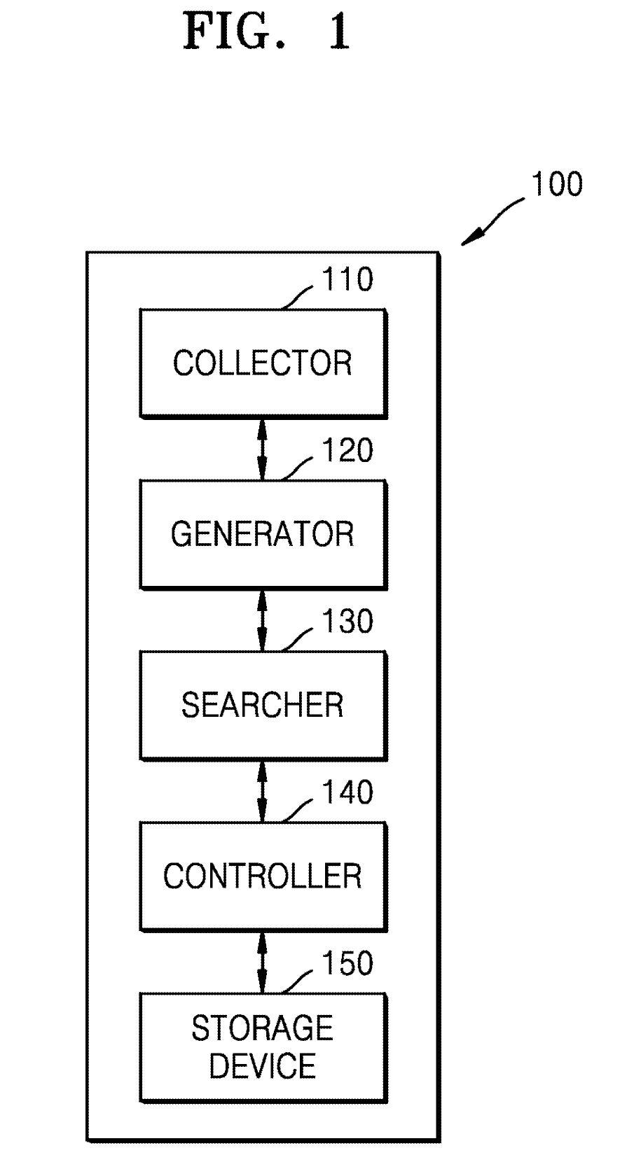

FIG. 1 is a diagram for roughly describing an information providing system according to an embodiment of the present invention.

Referring to FIG. 1, the information providing system 100 may include a collector 110, a generator 120, a searcher 130, a controller 140, and a storage 150 (e.g., a non-transitory storage device).

The collector 110 may collect user related information. The user related information collected by the collector 110 may be stored in the storage 150, and the user related information stored in the storage 150 may be updated in real time and/or periodically.

The user related information may include text information that a user inputs to a user terminal. The text information may be a search word to that the user inquires by using an Internet search engine. When the user inputs a search word on a search engine, the search engine may provide information related to the corresponding search word. For example, the user may input “Ryu Hyun-Jin” as a search word by using an Internet search engine (for example, naver) displayed on the user terminal. As a search result, profile information, news, websites, webpages, videos, blogs, images, encyclopedia, cafes, special information, books, maps, music, and interest information, which are related to “Ryu Hyun-Jin”, may be output as information such as opencast, related search words, magazines that any one can easily share. The collector 110 periodically counts the number of appearances of a search word text input on a search engine. When the number of appearances of the search word text is greater than or equal to a preset number of times, the collector 110 may recognize the search word text as user related information and store the search word text in the storage 150.

Also, the text information may include a webpage IP address text and/or a uniform resource locator (URL) address text that the user inputs on the user terminal. The collector 110 periodically counts the number of appearances of the website IP address text and/or the URL address text. When the number of appearances of the website IP address text and/or the URL address text is greater than or equal to a preset number of times, the collector 110 may recognize the webpage IP address text and/or the URL address text as user related information and store the webpage IP address text and/or the URL address text in the storage 150.

Also, the text information may include a keyword text included in a main body transmitted to another user terminal by executing an e-mail application, a text application, a social network service (SNS) application, or the like on the user terminal. When the user transmits or receives information to or from another user by executing the e-mail application, the text application, the SNS application, or the like, the information may include keyword texts that the user is interested in. Therefore, the collector 110 counts the number of appearances of a keyword text in the main body. When the number of appearances of the keyword text is greater than or equal to a preset number of times, the collector 110 may recognize the keyword text as user related information and store the keyword text in the storage 150.

Furthermore, in a case where the user terminal supports speech recognition, the collector 110 may extract a keyword voice from voice information input by the user and counts the number of appearances of the keyword voice. When the number of appearances of the keyword voice is greater than or equal to a preset number of times, the collector 110 may recognize the keyword voice as user related information and store the keyword voice in the storage 150.

Also, the user related information may include browsing history information of the user. The browsing history may include history information of Internet browser applications executed by the user. For example, the user may execute a news website or webpage and may view news stories about one or more topics of interest. The browsing history may include a URL of each news story that the user viewed. Therefore, the collector 110 counts the number of executions of a specific Internet browser application. When the number of executions of the specific Internet browser application is greater than or equal to a preset number of times, the collector 110 may recognize the Internet browser application as user related information and store the Internet browser application in the storage 150. One or more keyword text, whose number of appearances is greater than or equal to a preset number of times among pieces of information displayed by executing the specific browser application recognized as the user related information, may also be recognized as the user related information and stored in the storage 150.

Also, the user related information may include schedule information of the user. The user may execute a schedule management application that allows the user to set schedule information, and may input schedule information to an arbitrary date. The schedule information may include information about a date, a time, a place, a schedule title, a person to see, and/or a task to be processed. When the setting of the schedule information is completed, summary information of the corresponding schedule may be displayed on a calendar that is output after the execution of the schedule management application, so that the user intuitively views the schedule. Additionally, or alternatively, the presence of a schedule may be provided in the form of an alarm before a scheduled date and time. Additionally, or alternatively, an alarm may be provided at the scheduled time. The schedule information may be collected as the user related information, without regard to the number of appearances thereof. Therefore, the collector 110 may recognize the schedule information as the user related information and store the schedule information in the storage 150.

Also, the user related information may include any information set by the user. Any information set by the user may include information that the user is interested in on an interest information setting screen provided by the user terminal and wants to receive as event contents. For example, a category, a type, a keyword, and the like may be set. For example, the user may set a performance category or keyword on the interest information setting screen. After the setting of the performance category or keyword is completed, event contents related to the performance or concert may be output to the user terminal. Additionally, or alternatively, the user may set a travel category or keyword on the interest information setting screen. After the setting of the travel category or keyword is completed, event contents related to the travel may be output to the user terminal. Any information set by the user may be collected as the user related information, without regard to the number of appearances thereof. Therefore, the collector 110 may recognize any information set by the user as the user related information and store the information in the storage 150.

Also, the user related information may include context information of the user. The context information of the user may include a user's gender, age, preference of advertisement or application, ordinary commuting path, visit, call pattern (for example, private/business call, time, period, or the like), home/office addresses, web connection history, search log, occupation, income, monthly income, consumption pattern, and the like, may include a time, a user's location, moving direction, recent location, motion, recent call log, short message history, and the like, and may further include schedule information of the user. The context information of the user may be collected by sensing devices provided in the user terminal, for example, a GPS, a timer, a motion detection device, a gyro sensor, and the like, and the collector 110 may collect and store the context information of the user in the storage 150.

The collector 110 may continuously collect the user related information in real time and/or periodically through an interaction between the user and the applications capable of acquiring the user related information or an interaction between the user and the sensing devices capable of acquiring the user related information.

The generator 120 may generate predicted user interest information based on the user related information collected and stored in the storage 150 by the collector 110. The predicted user interest information may include potential information regarded as being interested in by the user and generated through analysis of the user related information. The predicted user interest information generated by the generator 120 may be stored in the storage 150, and the predicted user interest information stored in the storage 150 may be updated in real time and/or periodically.

The generator 120 may generate the predicted user interest information through analysis of text information input to the user terminal by the user. For example, the generator 120 may generate baseball as the predicted user interest information by analyzing and classifying the number of appearances and the appearance frequency of search word texts such as Ryu Hyun-Jin, WBC, homerun, and the like. Also, for example, the generator 120 may generate performance as the predicted user interest information by analyzing and classifying the number of appearances and the appearance frequency of keyword texts such as concert, singer, art center, and the like, which are included in a main body transmitted to another user terminal by executing an e-mail application, a text application, an SNS application, or the like on the user terminal. Also, for example, in a case where the user frequently visits websites or webpages, where keywords related to the world cup and soccer players frequently appear, by using the Internet browsing application executed on the user terminal, the generator 120 may generate soccer as the predicted user interest information through analysis of the websites or webpages.

Also, the generator 120 may generate the predicted user interest information through analysis of schedule information input to the user terminal by the user. For example, the generator 120 may analyze schedule information of Chinese study at Jongno Starbucks at 2:00 PM on Jul. 19, 2014, and generate a weather report for Jongno, a user's moving path (e.g., commuting directions) from a current location to Jongno Starbucks, coffee, Starbucks, Starbucks coupon, Chinese language, and the like as the predicted user interest information.

Also, the generator 120 may generate the corresponding information and information related to the corresponding information as the predicted user interest information through analysis of any information set by the user.

Also, the generator 120 may generate the predicted user interest information through analysis of context information of the user. For example, the generator 120 may analyze a user's behavior pattern and a user's previous behavior, define a triggering rule and a resetting rule suitable for the user, and produce a user's pattern. The triggering rule is provided for a condition that is placed in a specific situation in the user's behavior pattern, and the resetting rule is provided for a condition that starts the specific situation in the user's behavior pattern. For example, in a case where an adult male user was located in an entertainment region late last night, the generator 120 may generate hangover soup as the predicted user interest information in the next morning, based on the triggering rule that the user wants to eat a hangover soup in the next morning. Also, with respect to a user who studies English conversation five times a week, after the user's behavior is reset because the user studied English conversation five times last week, and then the user does not still start studying English conversation this week, the generator 120 may generate English conversation as the predicted user interest information.

The searcher 130 may search for an event including certain time information based on the predicted user interest information generated by the generator 120.

The event may be information that includes the predicted user interest information or can be provided to the user in relation to the predicted user interest information. For example, the event may include news information, website information, webpage information, blog information, image information, cafe information, map information, content information, (video, music, music, document, magazine, book, and the like), opencast information, shopping information, advertisement information, and the like. The event is not limited to the above examples. The event may include the predicted user interest information or may include any information that is searchable on the Internet in relation to the predicted user interest information.

Also, the event may include time information. The time information may be time information about the time when the event occurs or may include time information included in the event.

For example, with respect to the predicted user interest information related to “Ryu Hyun-Jin”, the searcher 130 may search for an event including website information, webpage information, blog information, or the like, which includes a pitching schedule (time information) of Ryu Hyun-Jin. Also, for example, the searcher 130 may analyze schedule information of Chinese study at Jongno Starbucks at 2:00 PM on Jul. 19, 2014, and search for an event including predicted weather information of 2:00 PM, map information, information about a Starbucks coupon available at 2:00 PM, or the like with respect to the predicted interest information about a weather in Jongno, a user's moving path from a current location to Jongno Starbucks, coffee, Starbucks, Starbucks coupon, Chinese language, and the like. Also, for example, with respect to predicted user interest information about a user's favorite singer, the searcher 130 may search for an event including website information or webpage information including the time when the singer releases a new album, or website or webpage information including sound source information that allows the user to listen to music in the new album.

Also, the searcher 130 may set the ranking of a plurality of events including time information and search for only events having a certain ranking or higher as valid events. Since a large number of events including the predicted user interest information exist, it is impossible to provide all the events to the user terminal. Therefore, the searcher 130 may set the ranking of the plurality of events and provide only the events having the certain ranking or higher to the user terminal as the valid events. Generally, search engines use a keyword frequency and a keyword position on websites or webpages so as to determine the ranking of the websites or webpages as an Internet keyword search result. Similarly, the searcher 130 may set the ranking of events based on the keyword frequency and position on the events. For example, predicted weather information, map information, and Starbucks coupon information may be respectively set as the first ranking, the second ranking, and the third ranking from events detected with respect to the Chinese study at Jongno Starbucks at 2:00 PM on Jul. 19, 2014, for example, predicted weather information of 2:00 PM, map information, information about a Starbucks coupon available at 2:00 PM.

Also, the searcher 130 may search for public interest events corresponding to interest information of the public except for the predicted user interest information. The public interest events may include information regarded as being searched for with interest by the general public including the user. For example, the public interest events may include weather, fortune, real-time traffic information, incident/accident information, movie information, stock information, and the like.

The controller 140 performs control so that event contents including time information are output to the user terminal together with a timeline dividing the time. In particular, the controller 140 controls the output of the event contents including the time information corresponding to the time of the timeline on the timeline dividing the time.

The timeline may be represented by a straight-line-shaped user interface including one or more time indicators that divides the time. The timeline may be output without overlapping the event contents output to the user terminal. The controller 140 may perform control so that the event contents including the time information matching the time indicator are output under a certain time indicator displayed on the timeline. For example, in a case where a current time indicates 2:00 PM on Jul. 19, 2014, the controller 140 may perform control so that contents of a weather prediction event of 2:00 PM, contents of a map event, and contents of a Starbucks coupon event available at 2:00 PM are output under a time indicator displaying 2:00 PM on the timeline.

The controller 140 may perform control so that main event contents among events are sequentially output by reception of gestures of a first direction and a second direction from event contents including the timeline.

The gesture may include a hand gesture (for example, tap, touch & hold, double tap, drag, panning, flick, drag-and-drop, or the like) that the user uses for controlling the information providing system 100, an operation of manipulating an input device such as an electronic pen, a mouse, a keyboard, or the like, or an operation of manipulating a wearable device when the user wears the wearable device such as glasses or the like.

The tap indicates an operation in which the user touches a screen quickly with his or her finger or by using a touch tool (stylus). That is, the tap indicates a case where a time difference between a touch-in time when the user's finger or the touch tool contacts the screen and a touch-out time when the user's finger or the touch tool moves away from the screen is very short. The touch & hold indicates an operation in which the user touches the screen with his or her finger or by using a touch tool (stylus) and then the touch input is maintained for a critical time or more. That is, the touch & hold indicates a case where a time difference between a touch-in time and a touch-out time is greater than or equal to a critical time. In order to allow the user to recognize whether a touch input is the tap or the touch & hold, if the touch input is maintained for the critical time or more, a feedback signal may be provided visually or audibly. Also, the drag indicates an operation in which the user touches the screen with his or her finger or by using a touch tool and moves his or her finger or the touch tool to another position on the screen while maintaining the touch. When a drag operation is performed, an object is moved or a panning operation to be described below is performed. Also, the panning indicates a case where the user performs a drag operation without selecting an object. Since the panning does not select a specific object, an object is not moved within a page, but the page itself is moved within the screen or a group of objects is moved within the page.

Also, the main event contents may include an event corresponding to the first ranking among events which include time information and to which the ranking is set. Also, the main event contents may include event title information in which a keyword found from the events whose ranking is set by the controller 140 is combined with a background image generated or found in relation to the keyword. Also, the first direction may indicate a direction in which a future time indicator is displayed with respect to a current time indicator on a timeline. Also, the second direction may indicate a direction opposite to the first direction, in which a past time indicator is displayed with respect to a current time indicator on a timeline. In other words, the first direction and the second direction may indicate a horizontal direction.

Also, the controller 140 may perform control so that detailed event contents related to the main event contents are output by reception of a gesture of a third direction from event contents including the timeline. The detailed event contents may include events having the remaining ranking except for the event corresponding to the first ranking among events which include time information and to which the ranking is set. Also, the detailed event contents may include events which are output under the event title information generated by the controller 140 and to which the ranking is set. The detailed event contents may be located under the main event contents. Also, the third direction may indicate a direction in which the detailed event contents can be output from the beginning of the main event contents. The third direction may indicate a vertically downward direction. Also, a fourth direction to be described below may indicate a direction in which the main event contents can be output from the beginning of the detailed event contents. The fourth direction may indicate a vertically upward direction.

In the present embodiment, a plurality of different main events may be output under the time indicator of the timeline. The different main events may include a main event where no detailed event information exists and a main event where one or more pieces of detailed event information exist. The ranking may be set to the different main events and the main events may be output in the ranking order.

Also, the controller 140 may perform control so that event contents including time information corresponding to the gesture of the first direction are output on the user terminal by reception of the gesture of the first direction from the event contents including the timeline, and may perform control so that event contents including time information corresponding to the gesture of the second direction are output by reception of the gesture of the second direction from the event contents including the timeline. For example, when it is assumed that a current time is based on 2:00 PM on Jul. 19, 2014, the time indicator of the timeline may display 4:00 PM by the reception of the gesture of the first direction. For example, the controller 140 may perform control so that event contents set as the predicted user interest information and allowing the user to listen to a sound source of a singer releasing a new song at 4:00 PM may be output under the time indicator displaying 4:00 PM. Also, when it is assumed that a current time is based on 2:00 PM on Jul. 19, 2014, the time indicator of the timeline may display 11:00 AM by the reception of the gesture of the second direction. For example, the controller 140 may perform control so that event contents set as the predicted user interest information and including a website or webpage reporting that the baseball player Ryu Hyun-Jin will take the mound at 11:00 AM may be output under the time indicator displaying 11:00 AM. Also, in spite of the gesture of the first direction and/or the gesture of the second direction, an event including the predicted user interest information may not exist. In this case, the controller 140 may perform control so that public interest events are output.

Also, the controller 140 may perform control so that event contents including time information corresponding to the gesture of the first direction are output by the reception of the gesture of the first direction on the timeline, and may perform control so that event contents including time information corresponding to the gesture of the second direction are output by the reception of the gesture of the second direction on the timeline. In the contents described earlier, the cause of moving the event contents in the first or second direction is a user gesture on the event contents, and the corresponding contents are different in that the cause of moving the event contents is a user gesture on the timeline.

Furthermore, the controller 140 may perform control so that the event contents including the time information matching the selected time indicator are output in response to a gesture (for example, a tap or a double tap) of selecting a certain time on the timeline. The gesture of selecting the certain time on the timeline may include any gestures of selecting a certain time on the timeline, including a gesture of selecting a certain time on the timeline where a current time is displayed, a gesture of selecting a certain time on the timeline after moving in a first direction or a second direction, and the like.

The storage 150 may store the user related information collected by the collector 110, the predicted user interest information generated by the generator 120, and the event found by the searcher 130, and may update the pieces of information in real time and/or periodically under the control of the controller 140.

The storage 150 is illustrated in FIG. 1 as being provided in the information providing system 100, but the invention is not necessarily limited thereto. The storage 150 may be present as a separate database server or may be electrically connected to the information providing system 100 via a wired and/or wireless communication network. This may be equally applied to all the following embodiments of the present invention. The expression “electrically connected” as used herein includes “connection of electrical signals via a wireless communication network” as well as “connection of electrical signals via a wired circuit network”.

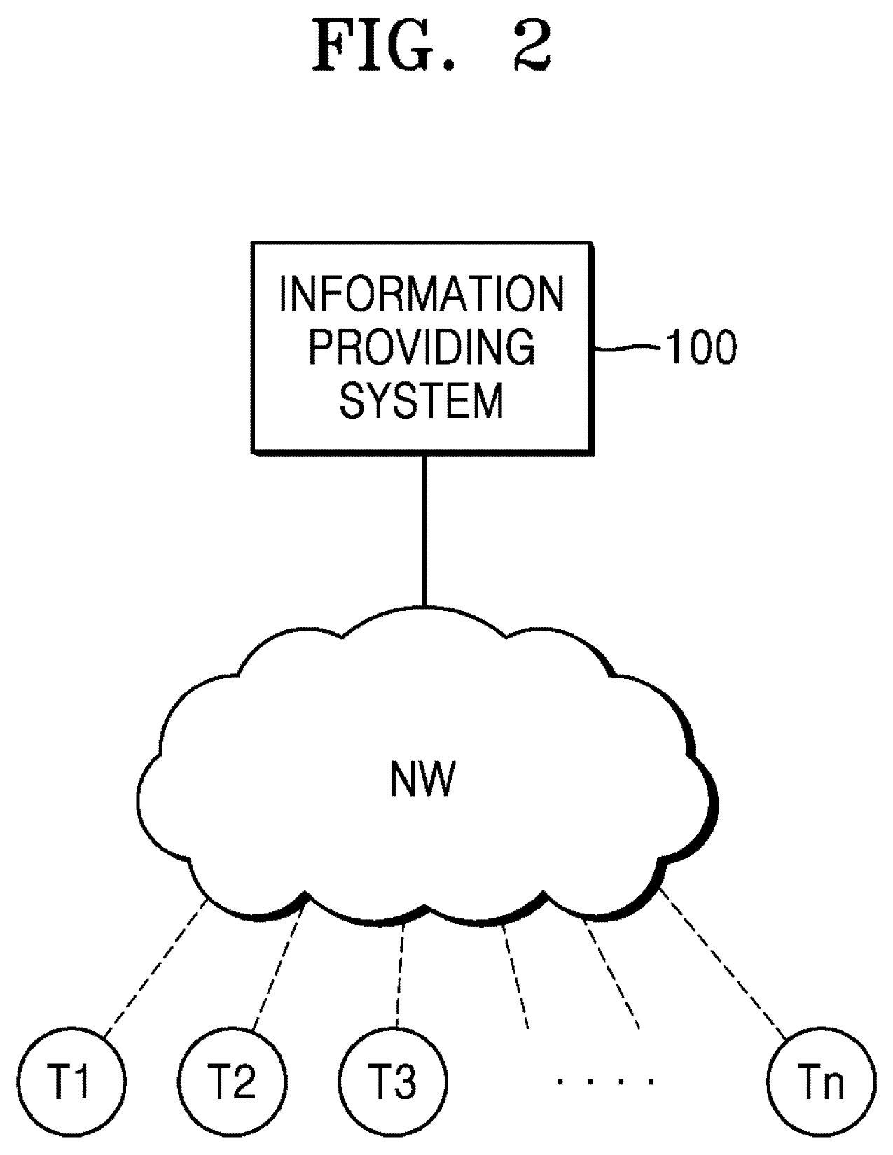

FIG. 2 is a diagram for describing a relationship between user terminals and the information providing system 100 of FIG. 1, according to an embodiment of the present invention.

Referring to FIG. 2, the information providing system 100 may be connected to a plurality of user terminals T1, T2, T3, . . . , Tn via a network NW including wired and/or wireless communication networks such as Internet and/or Intranet. That is, the information providing system 100 may be separated from the user terminals T1, T2, T3, . . . , Tn and connected to the user terminals T1, T2, T3, . . . , Tn in a state of being separated therefrom.

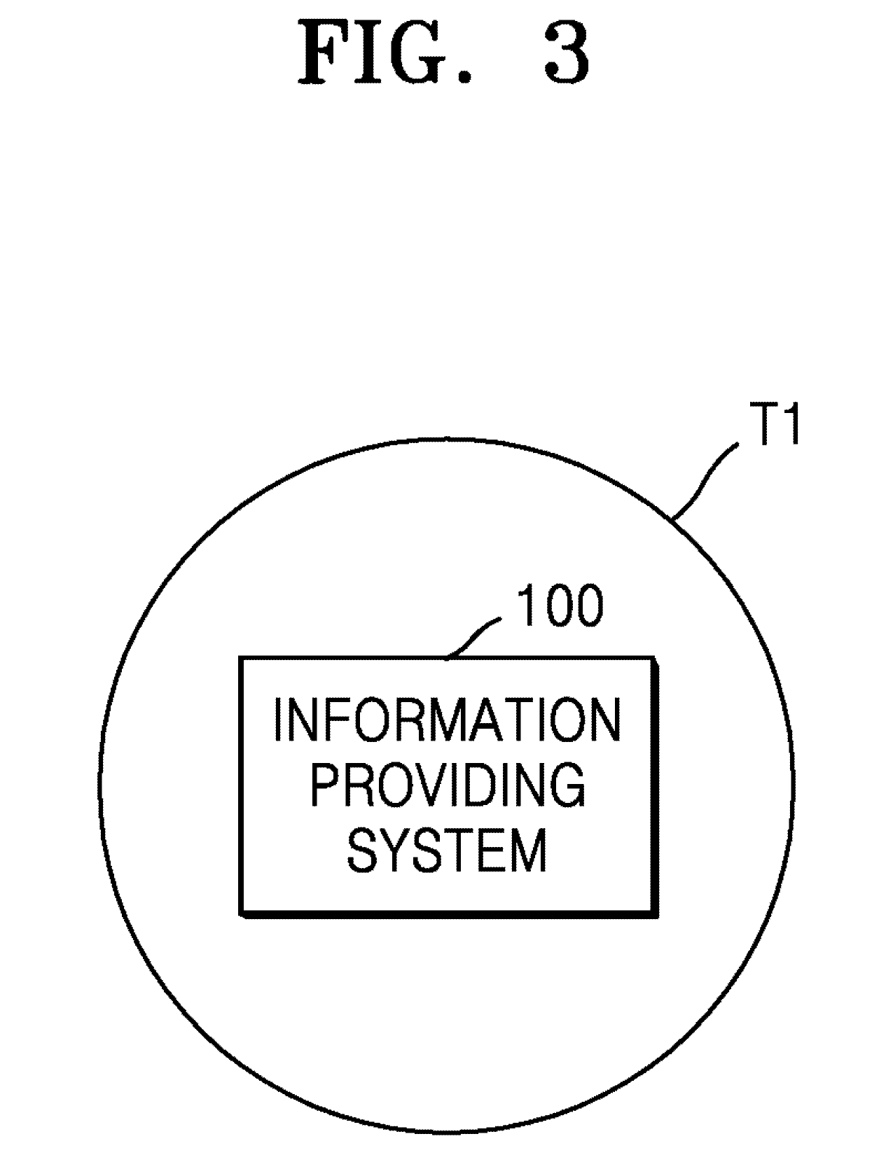

FIG. 3 is a diagram for describing a relationship between a user terminal and the information providing system 100 of FIG. 1, according to another embodiment of the present invention.

Referring to FIG. 3, the information providing system 100 may be incorporated into the user terminal T1. Although not illustrated, the information providing system 100 may be incorporated into a terminal of each user. There are various methods of incorporating the information providing system 100 of the present embodiment into the user terminal T1. As a specific embodiment, each user may install the information providing system 100 in the terminal via the network NW. For example, the user may install the information providing system 100 in the user terminal T1 in the form of an application. As another specific embodiment, the information providing system 100 may be installed in the user terminal T1 via an offline. However, this is merely an example and the present invention is not limited thereto. The information providing system 100 may be installed in the user terminal T1 in various forms.

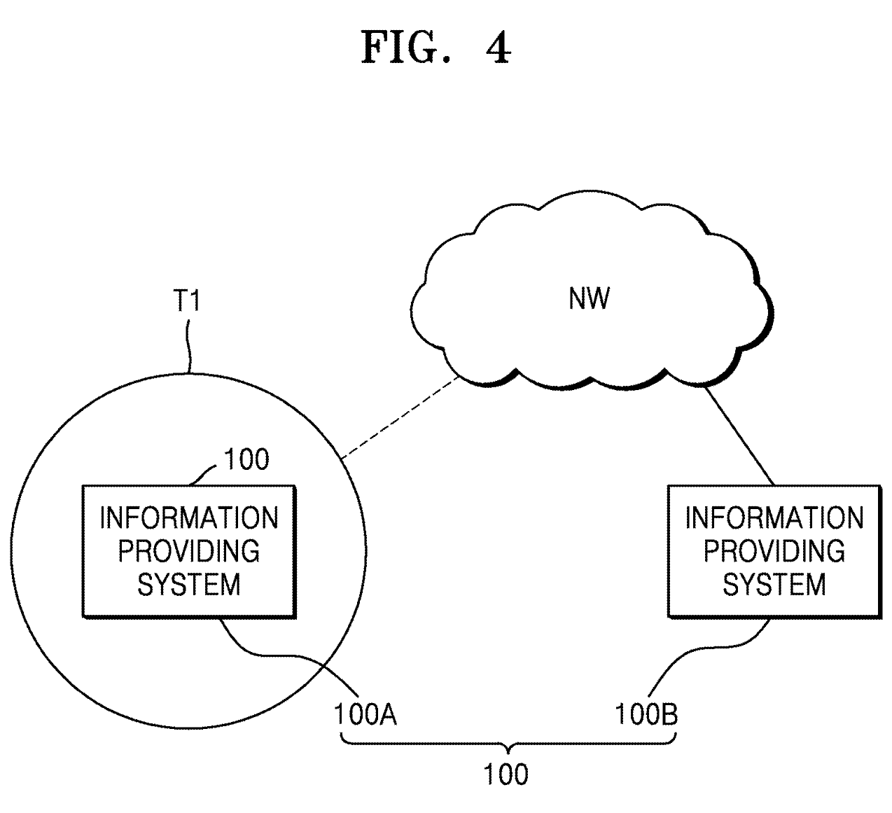

FIG. 4 is a diagram for describing a relationship between a user terminal and the information providing system 100 of FIG. 1, according to another embodiment of the present invention.

Referring to FIG. 4, a part 100A of the information providing system 100 may be incorporated into the user terminal T1, and another part 1008 thereof may be connected to the user terminal T1 via a network NW.

For example, the part 100A including the collector 110, the generator 120, the searcher 130, and the controller 140 among the elements of the information providing system 100 illustrated in FIG. 1 may be incorporated into the user terminal T1. Since a method of incorporating the part 100A of the information providing system 100 into the user terminal T1 is the same as described in the embodiment of FIG. 3, detailed descriptions thereof will be omitted. Also, another part 1008 including the storage 150 among the elements of the information providing system 100 illustrated in FIG. 1 may be provided outside the user terminal T1 and connected to the user terminal T1 via the network NW.

In the present embodiment, a case where the storage 150 of the information providing system 100 is connected to the user terminal T1 as the part 1008 via the network NW has been described, but this is merely an example and the present invention is not limited thereto. That is, at least one of the plurality of elements included in the information providing system 100 may be selectively connected to the user terminal T1 via the network NW.

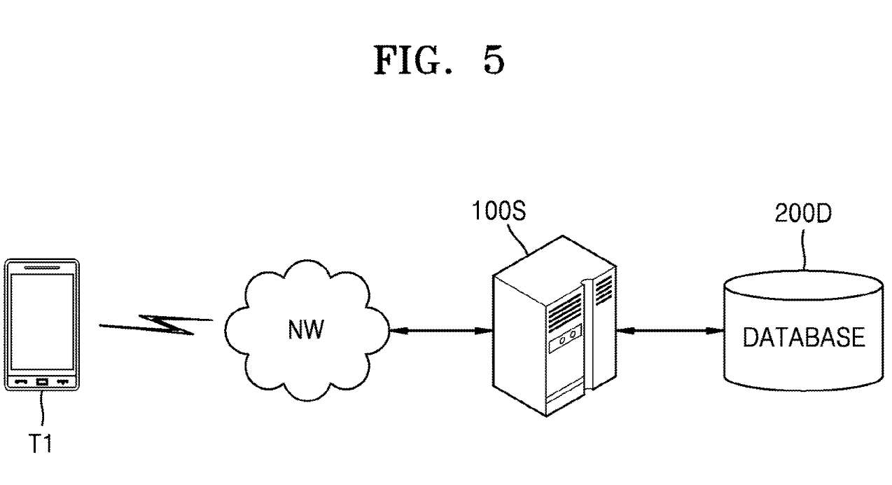

FIG. 5 is a diagram for roughly describing an information providing system 100 according to another embodiment of the present invention. In the following description, portions redundant with the description provided above with reference to FIGS. 1 to 4 will not be described.

Referring to FIG. 5, the information providing system 100 may be implemented by an information providing server 100S, and a user terminal T1 may be connected to the information providing server 100S via a network NW. Also, the information providing server 100S may be connected to a database 200D. Information stored in the database 200D may be provided to the user terminal T1 through the information providing server 100S, or information received from the user terminal T1 may be stored in the database 200D through the information providing system 100S. Contents of the database 200D are identical to the contents of the storage 150 of FIG.

The user terminal T1 is a device that may connect to the information providing server 100S via the network NW. The user terminal T1 may be a mobile terminal such as a notebook, a handheld device, a smartphone, a tab, or a tablet PC, a desktop computer, or any devices using such devices or directly or indirectly connected thereto. The user terminal T1 may connect to the information providing server 100S and receive event contents corresponding to predicted user interest information provided even without any search word input.

The information providing system 100S may collect information related to a user holding the user terminal T1, generate predicted user interest information based on the user related information, search for an event including certain time information corresponding to the predicted user interest information, control the output of event contents together with a timeline dividing the time, generate event contents including time information matching a certain time on the timeline, and provide the event contents to the user terminal T1.

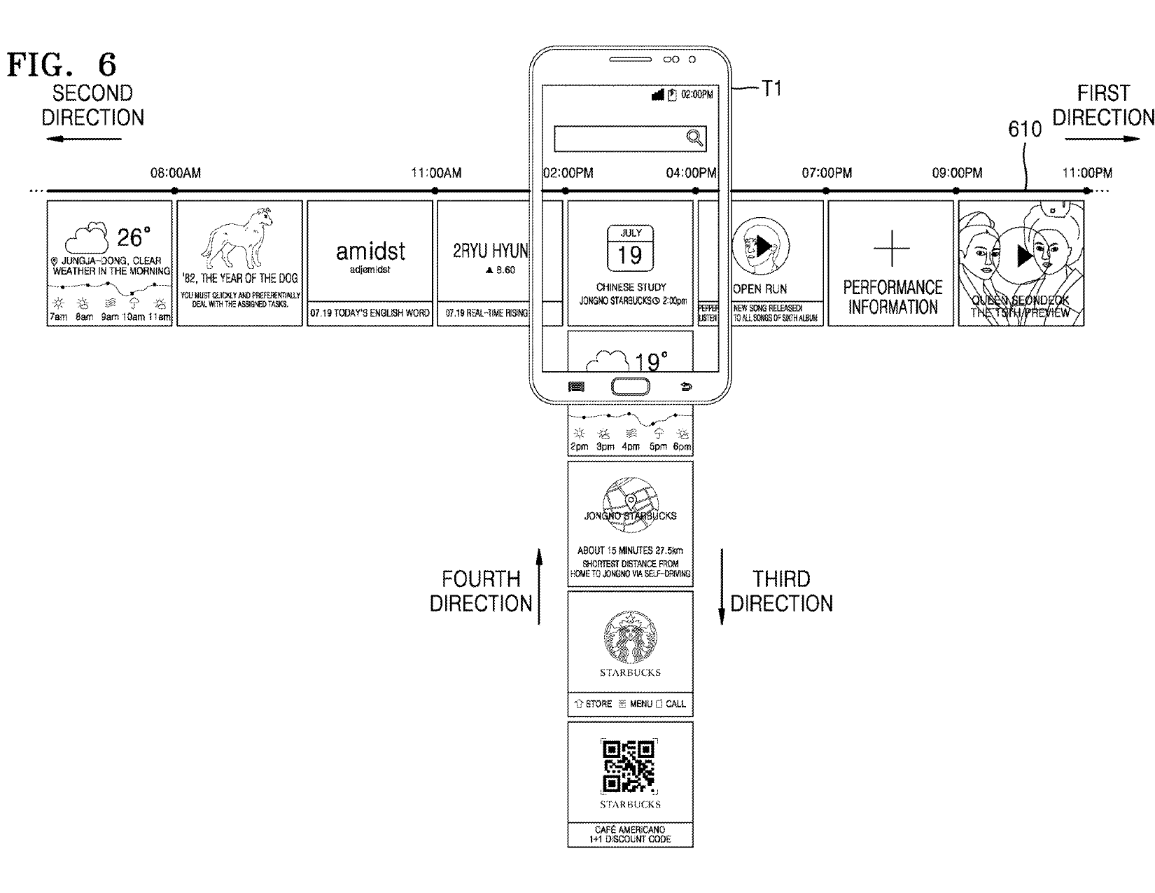

FIG. 6 is a diagram illustrating an example of an information providing screen according to an embodiment of the present invention.

FIG. 6 illustrates an example in which an information providing system 100 provides event contents including time information matching the time indicator according to a time indicator on a timeline 610. For example, at 11:00 AM based on today's date, Jul. 19, 2014, the information providing system 100 may provide, to the user terminal T1, event contents related to “Ryu Hyun-Jin” as an event that corresponds to user prediction information and includes time information of 11:00 AM. Also, FIG. 6 illustrates an example in which the information providing system 100 provides, to the user terminal T1, event contents including event title information, weather information, map information, Starbucks information, and Starbucks coupon information as an event corresponding to schedule information of the user, based on a current time, 2:00 PM on Jul. 19, 2014. Also, for example, at 4:00 PM based on today's date, Jul. 19, 2014, the information providing system 100 may provide, to the user terminal T1, event contents including a website or webpage corresponding to the user prediction information and allowing a user to listen to a sound source of a singer releasing a new song at 4:00 PM.

On the information providing screen of FIG. 6, the information providing system 100 may provide, to the user terminal T1, main event contents among events by reception of gestures of a first direction and a second direction from the event contents including the timeline 610, and may provide, to the user terminal T1, detailed event contents related to the main event contents by reception of a gesture of a third direction different from the first direction and the second direction from the event contents including the timeline 610.

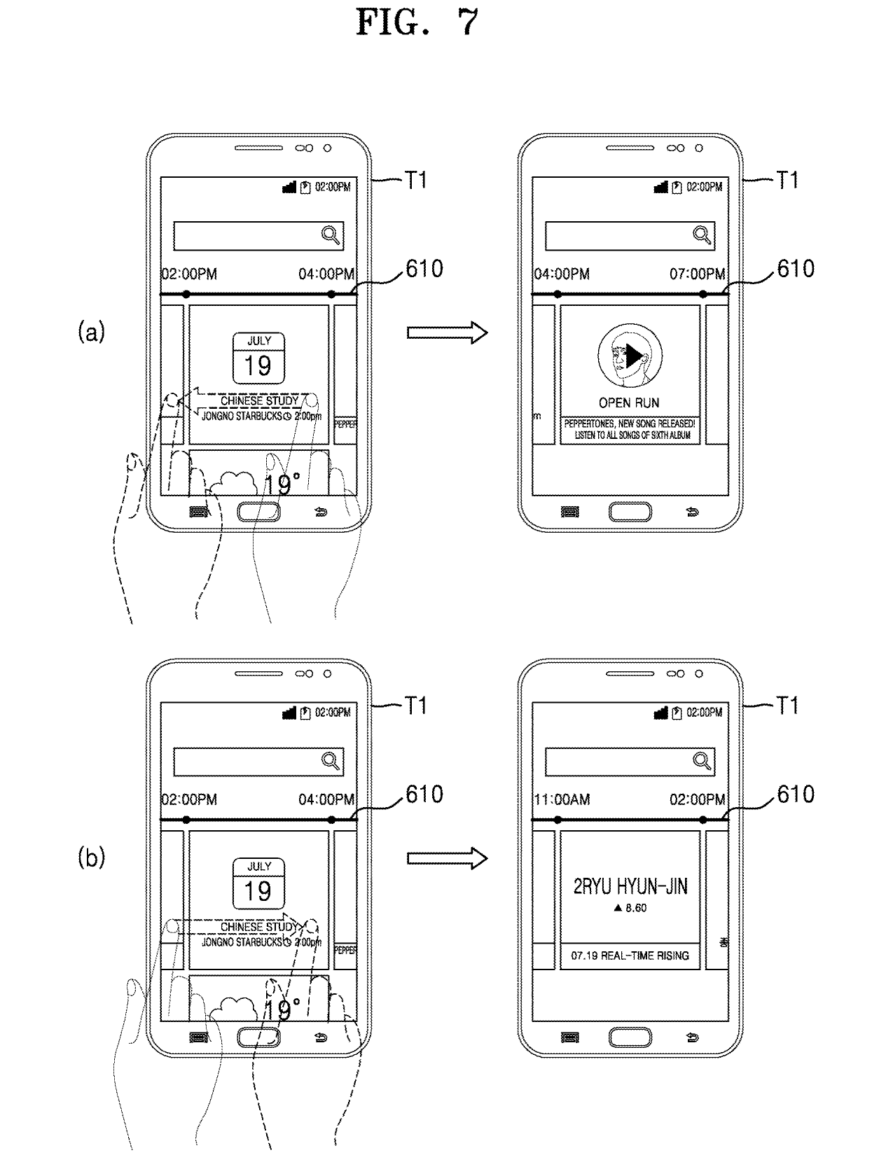

FIG. 7 is a diagram illustrating an example of an information providing screen according to another embodiment of the present invention.

Referring to FIG. 7(a), the information providing system 100 may provide main event contents including time information matching a time indicator of a first direction by reception of a gesture of the first direction from main event contents including the timeline 610 on the user terminal T1. For example, when it is assumed that a current time is based on 2:00 PM on Jul. 19, 2014, the time indicator of the timeline 610 may display 4:00 PM by the reception of the gesture of the first direction. For example, the information providing system 100 may provide, to the user terminal T1, main event contents set as the predicted user interest information and including a website or webpage allowing the user to listen to a sound source of a singer releasing a new song at 4:00 PM, under the time indicator displaying 4:00 PM.

Referring to FIG. 7(b), the information providing system 100 may provide main event contents including time information matching a time indicator of a second direction by reception of a gesture of the second direction from main event contents including the timeline 610 on the user terminal T1. For example, when it is assumed that a current time is based on 2:00 PM on Jul. 19, 2014, the time indicator of the timeline 610 may display 11:00 AM by the reception of the second-direction gesture. For example, the information providing system 100 may provide, to the user terminal T1, main event contents set as the predicted user interest information and including a website or webpage reporting that the baseball player Ryu Hyun-Jin will take the mound at 11:00 AM, under the time indicator displaying 11:00 AM.

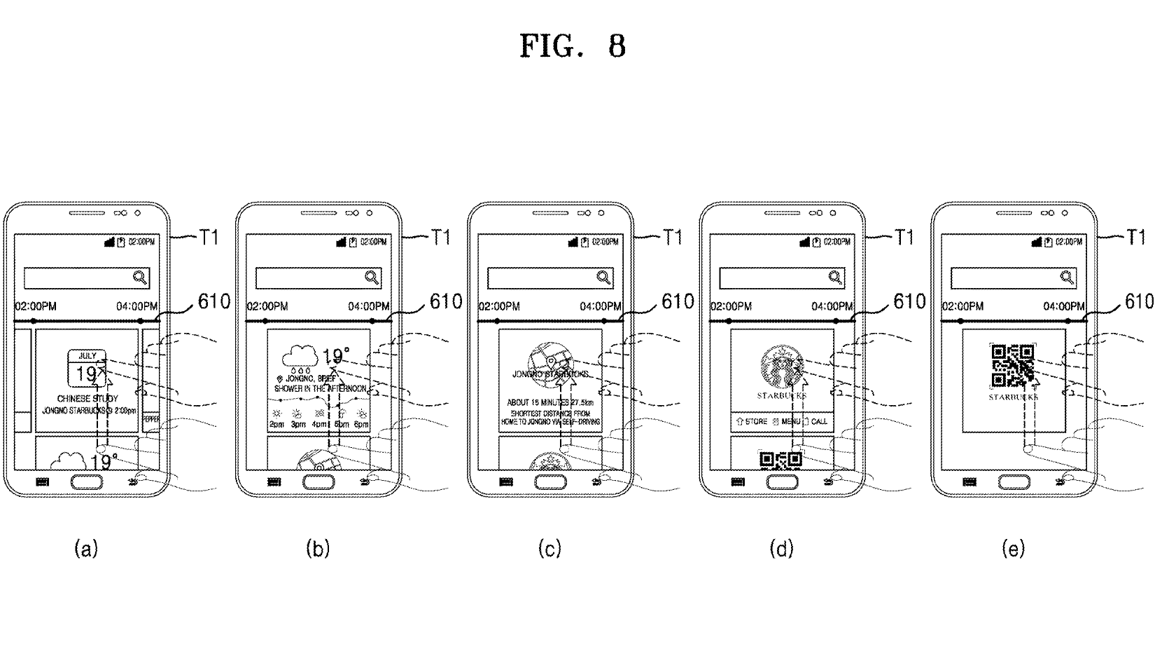

FIG. 8 is a diagram illustrating an example of an information providing screen according to another embodiment of the present invention.

Referring to FIG. 8, the information providing system 100 may provide detailed events to a user terminal T1 by reception of a gesture of a third direction from main event contents including the timeline 610.

FIG. 8(a) shows a primary gesture performed in a third direction so as to view detailed event contents from main event contents corresponding to schedule information of the user, that is, event title information, on the assumption that a current time is based on 2:00 PM on Jul. 19, 2014.

FIG. 8(b) shows weather information as first detailed event contents according to a result of performing the primary gesture in the third direction so as to view the detailed event contents from the main event contents, and shows a secondary gesture operation performed in the third direction so as to view second detailed event contents.

FIG. 8(c) shows map information as second detailed event contents according to a result of performing the secondary gesture in the third direction, and shows a tertiary gesture operation performed in the third direction so as to view third detailed event contents.

FIG. 8(d) shows Starbucks related information as third detailed event contents according to a result of performing the tertiary gesture in the third direction, and shows a quaternary gesture operation performed in the third direction so as to view fourth detailed event contents.

FIG. 8(e) shows Starbucks coupon information as fourth detailed event contents according to a result of performing the quaternary gesture operation in the third operation.

A gesture of a fourth direction may be performed when the user wants to return to the main event contents from the detailed event contents.

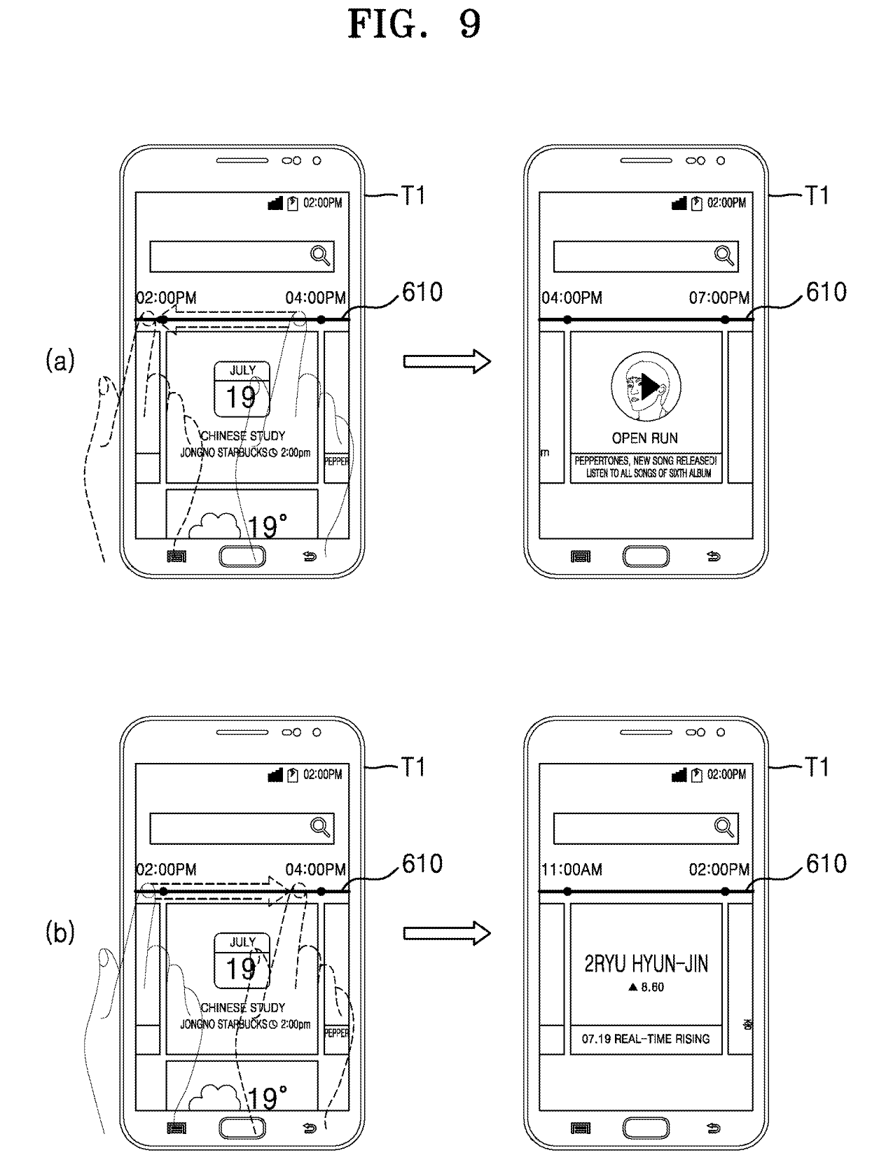

FIG. 9 is a diagram illustrating an example of an information providing screen according to another embodiment of the present invention.

Referring to FIG. 9, the information providing system 100 may provide, to a user terminal T1, main event contents among events by reception of gestures of a first direction and a second direction on a timeline 610. The case of FIG. 7 is to move the event contents in the first and second directions by the reception of the gesture, and the case of FIG. 9 is different in that not the event contents but the timeline 610 itself is moved in the first and second directions by the reception of the gesture.

Referring to FIG. 9(a), the information providing system 100 may provide, to a user terminal T1, main event contents including time information matching a time indicator of a first direction by reception of a gesture of a first direction on the timeline 610. For example, when it is assumed that a current time is based on 2:00 PM on Jul. 19, 2014, the time indicator of the timeline 610 may display 4:00 PM by the reception of the gesture of the first direction on the timeline 610. For example, the information providing system 100 may provide, to the user terminal T1, main event contents set as predicted user interest information and including a website or a webpage allowing the user to listen to a sound source of a singer releasing a new song at 4:00 PM, under the time indicator displaying 4:00 PM.

Referring to FIG. 9(b), the information providing system 100 may provide main event contents including time information matching a time indicator of a second direction by reception of a gesture of the second direction from main event contents including the timeline 610 on the user terminal T1. For example, when it is assumed that a current time is based on 2:00 PM on Jul. 19, 2014, the time indicator of the timeline 610 may display 11:00 AM by the reception of the gesture of the second direction on the timeline 610. For example, the information providing system 100 may provide, to the user terminal T1, main event contents set as the predicted user interest information and including a website or webpage reporting that the baseball player Ryu Hyun-Jin will take the mound at 11:00 AM, under the time indicator displaying 11:00 AM.

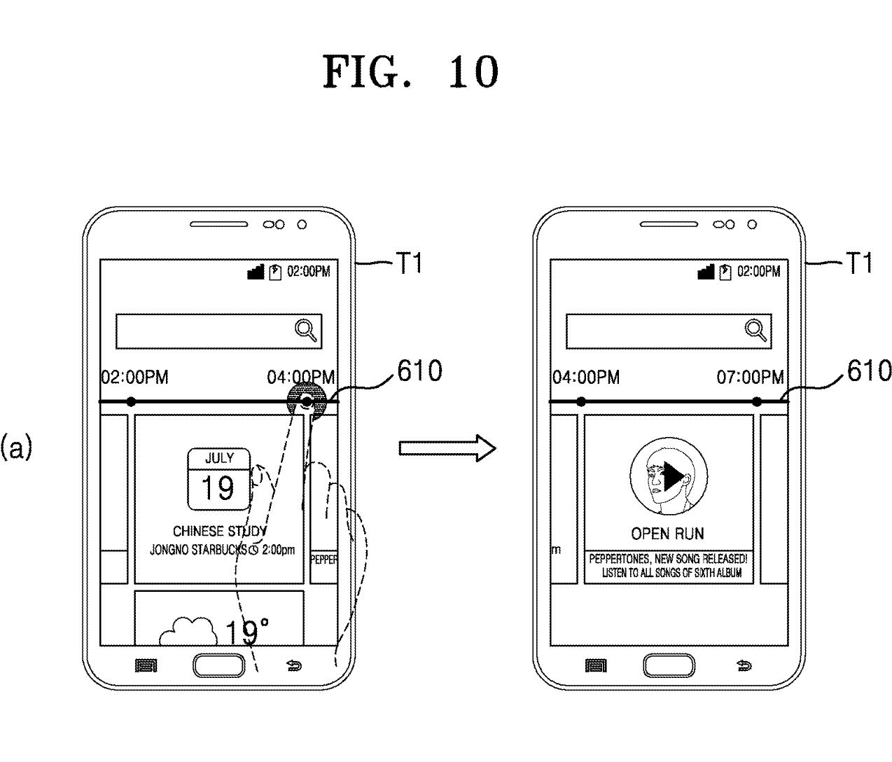

FIG. 10 is a diagram illustrating an example of an information providing screen according to another embodiment of the present invention.

Referring to FIG. 10, an information providing system 100 may perform control to output event contents including time information matching a selected time indicator in response to reception of a gesture of selecting a certain time on a timeline 610. For example, when it is assumed that a current time is based on 2:00 PM on Jul. 19, 2014, the information providing system 100 may provide, to the user terminal T1, main event contents set as the predicted user interest information and including a website or a webpage allowing the user to listen to a sound source of a singer releasing a new song at 4:00 PM in response to reception of a gesture of selecting a time indicator displaying 4:00 PM on the timeline 610.

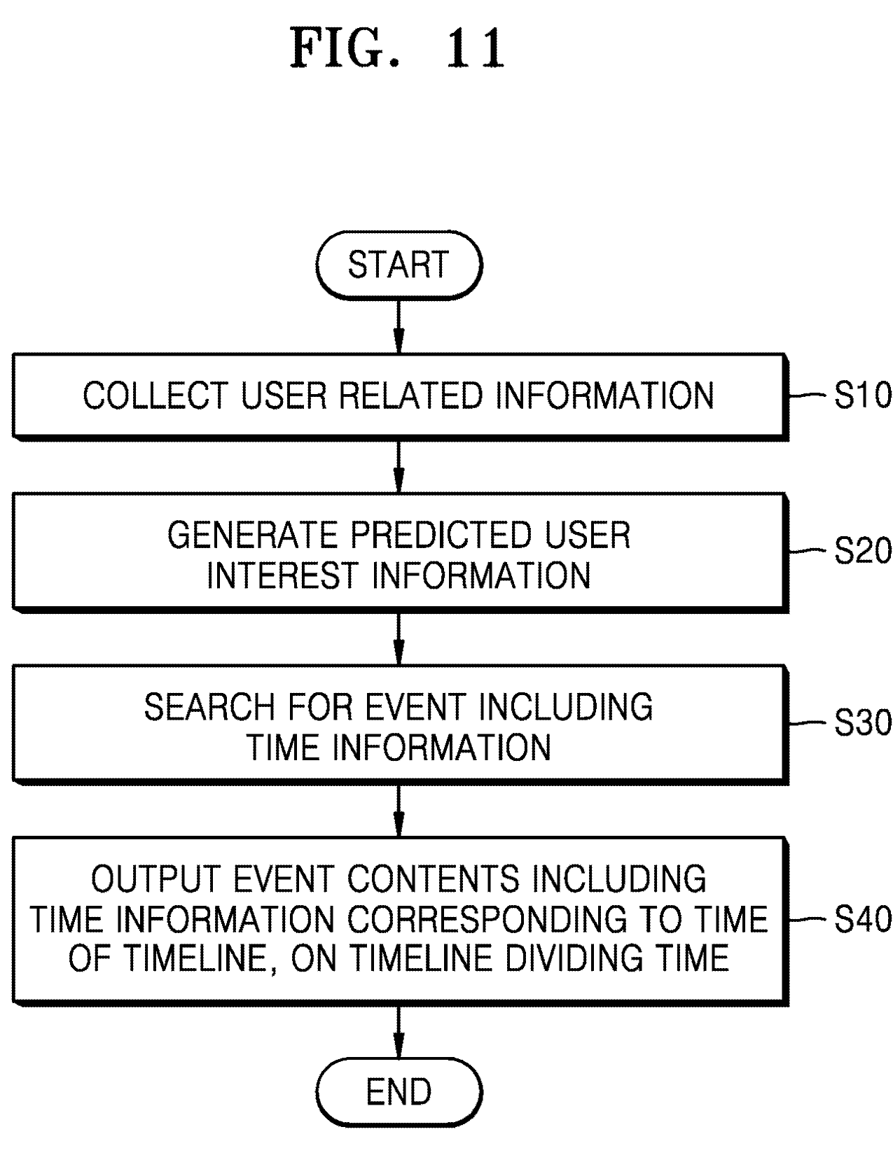

FIG. 11 is an operation flowchart of an information providing method according to an embodiment of the present invention. In the following description, portions redundant with the description provided above with reference to FIGS. 1 to 10 will not be described.

Referring to FIG. 11, the information providing system 100 collects information related to the user holding the user terminal (S10). The user related information may include text information input to the user terminal by the user, browsing history information of the user, schedule information of the user, information set by the user, and/or user context information.

When the user related information is collected, the information providing system 100 generates predicted user interest information based on the user related information (S20). The information providing system 100 may generate the predicted user interest information through analysis of the text information input to the user terminal by the user, the browsing history information of the user, the schedule information of the user, the information set by the user, and/or the user context information.

When the generating of the predicted user interest information is completed, the information providing system 100 searches for an event including certain time information corresponding to the predicted user interest information (S30). The information providing system 100 may set the ranking of a plurality of events including time information, search for only events ranked within a certain ranking as valid events, set the ranking of the valid events, and provide only events ranked within a certain ranking to the user terminal. Also, the information providing system 100 may search for public interest events corresponding to interest information of the public except for the user interest information.

When the searching for the events is completed, the information providing system 100 controls the output of event contents together with a timeline dividing time, and outputs, to the user terminal T1, event contents including the time information corresponding to the time of the timeline on the time line for dividing the time (S40).

The information providing system 100 may output, to the user terminal T1, main event contents by reception of gestures of a first direction and a second direction from the event contents including the timeline, and may output, to the user terminal T1, detailed event contents related to the main event contents by reception of a gesture of a third direction from the event contents including the timeline.

Also, the information providing system 100 may output, to the user terminal T1, event contents including time information corresponding to the gesture of the first direction by reception of the gesture of the first direction from the event contents including the timeline, and may output, to the user terminal T1, event contents including the time information corresponding to the gesture of the second direction by reception of the gesture of the second direction from the event contents including the timeline.

Also, the information providing system 100 may output, to the user terminal T1, event contents including time information corresponding to the gesture of the first direction by reception of the gesture of the first direction on the timeline, and may output, to the user terminal T1, event contents including the time information corresponding to the gesture of the second direction by reception of the gesture of the second direction on the timeline.

Also, the information providing system 100 may output, to the user terminal T1, event contents including time information matching a selected time in response to reception of a gesture of selecting a certain time on a timeline.

The methods according to embodiments may be embodied as computer-readable codes on a non-transitory computer-readable recording medium. The non-transitory computer-readable recording medium may be any recording medium that can store data which can be thereafter read by a computer system.

Examples of the non-transitory computer-readable recording medium may include read-only memory (ROM), random access memory (RAM), compact disk-ROMs (CD-ROMs), magnetic tapes, floppy disks, and optical data storage devices, and may also include media implemented in the form of carrier wave (e.g., transmission through the Internet). The non-transitory computer-readable recording medium can also be distributed over network-coupled computer systems so that the computer-readable code is stored and executed in a distributed fashion. In addition, functional programs, codes, and code segments for accomplishing the present invention can be easily construed by programmers skilled in the art to which the present invention pertains.

The use of the term “the” or a similar definite term in the specification (in particular, in the claims) may correspond to both the singular and the plural. In addition, when a range is disclosed in the embodiments, embodiments to which individual values belonging to the range are applied may be included (if there is no disclosure opposite to this), and this is the same as that each of the individual values forming the range is disclosed in the detailed description of the embodiments.

For steps forming the methods according to the present invention, if an order is not clearly disclosed or if there is no disclosure opposed to the clear order, the steps may be performed in a proper order. The present invention is not necessarily limited to the disclosed order of the steps. The use of all illustrations or illustrative terms (for example, and the like, etc.) in the embodiments is simply to describe the present invention in detail, and the scope of the present invention is not limited due to the illustrations or illustrative terms unless they are limited by claims. In addition, it will be understood by those of ordinary skill in the art that various modifications, combinations, and changes may be made according to design conditions and factors within the scope of the attached claims or the equivalents.

While embodiments of the present invention has been shown and described, it will be understood by those skilled in the art that various changes and modifications may be made without departing from the spirit and the scope of the invention as defined in the following claims.

### INDUSTRIAL APPLICABILITY

Embodiments of the present invention relate to information providing systems and methods and are applicable to information providing systems and methods that predict user interest information based on user related information and provide event contents including time information corresponding to predicted interest information according to time on a timeline, so that a user need not unnecessarily spend a search time in confirming event contents of interest.

1. An information providing system comprising:
a memory having computer readable instructions stored thereon; and
at least one processor configured to execute the computer readable instructions to,
collect user related information;
generate predicted user interest information based on the collected user related information;
search for an event including time information corresponding to the predicted user interest information; and
output, on a timeline, event contents associated with the event, the event contents including the time information corresponding to a time of the timeline.

2. The information providing system of claim 1, wherein
the collected user related information includes text input by the user; and
the predicted user interest information includes the text input.

3. The information providing system of claim 1, wherein
the user related information includes browsing history information of the user; and
the predicted user interest information includes text information included in the browsing history information.

4. The information providing system of claim 1, wherein
the user related information includes schedule information of the user; and
the predicted user interest information includes information corresponding to the schedule information.

5. The information providing system of claim 1, wherein
the user related information includes information set by the user; and
the predicted user interest information includes information corresponding to the information set by the user.

6. The information providing system of claim 1, wherein
the user related information includes context information of the user; and
the predicted user interest information includes information corresponding to the context information.

7. The information providing system of claim 1, wherein the at least one processor is further configured to:
search for a public interest event corresponding to public interest information except for the predicted user interest information; and
output contents associated with the public interest event.

8. The information providing system of claim 1, wherein the at least one processor is further configured to:
receive ranking gestures of a first direction and a second direction from the event contents included in the timeline;
output main event contents as an event corresponding to a first rank among the event contents; and
output detailed event contents related to the main event contents by reception of a gesture of a third direction.

9. The information providing system of claim 1, wherein the at least one processor is further configured to:
output the event contents including time information based on reception of a gesture of a first direction on the event contents included in the timeline; and
output the event contents including time information based on reception of a gesture of a second direction on the event contents included in the timeline.

10. The information providing system of claim 1, wherein the at least one processor is further configured to:
output the event contents including time information based on reception of a gesture of a first direction on the timeline; and
output the event contents including time information based on reception of a gesture of a second direction on the timeline.

11. The information providing system of claim 1, wherein the at least one processor is further configured to:
output the event contents including the time information matching a selected time in response to reception of a selection gesture on the time on the timeline.

12. An information providing method comprising:
collecting, using at least one processor, user related information;
generating, using the at least one processor, predicted user interest information based on the collected user related information;
searching for, using the at least one processor, an event including time information corresponding to the predicted user interest information; and
outputting, using the at least one processor, on a timeline, event contents associated with the event, the event contents including the time information corresponding to a time of the timeline.

13. The information providing method of claim 12, wherein
the user related information includes text input by the user; and
the predicted user interest information includes the text input by the user.

14. The information providing method of claim 12, wherein
the user related information includes a browsing history information of the user; and
the predicted user interest information includes text information included in the browsing history.

15. The information providing method of claim 12, wherein
the user related information includes schedule information of the user; and
the predicted user interest information includes information corresponding to the schedule information.

16. The information providing method of claim 12, wherein
the user related information includes information set by the user; and
the predicted user interest information includes information corresponding to the information set by the user.

17. The information providing method of claim 12, wherein
the user related information includes context information of the user; and
the predicted user interest information includes information corresponding to the context information.

18. The information providing method of claim 12, wherein
the searching comprises searching for a public interest event corresponding to public interest information except for the predicted user interest information; and
the outputting comprises outputting contents associated with the public interest event.

19. The information providing method of claim 12, wherein the outputting comprises:
receiving ranking gestures of a first direction and a second direction from the event contents included in the timeline,
outputting main event contents as an event corresponding to a first rank among the event content; and
outputting detailed event contents related to the main event contents by reception of a gesture of a third direction.

20. The information providing method of claim 12, wherein the outputting comprises:
outputting the event contents including time information based on reception of a gesture of a first direction on the event contents included in the timeline; and
outputting the event contents including time information based on a reception of a gesture of a second direction on the event contents included in the timeline.

21. The information providing method of claim 12, wherein the outputting comprises:
outputting the event contents including time information based on reception of a gesture of a first direction on the timeline; and
outputting the event contents including time information based on reception of a gesture of a second direction on the timeline.

22. The information providing method of claim 12, wherein the outputting comprises:
outputting the event contents including the time information matching a selected time in response to reception of a selection gesture on the time on the timeline.

23. A non-transitory computer-readable recording medium having recorded thereon a computer program for performing the method of claim 12.
